(19) United States
(12) Patent Application Publication
(10) Pub. No.: US 2026/0048776 A1
(43) Pub. Date: Feb. 19, 2026

(54) MOBILE WORKSTATION

(71) Applicant: TILTA INC., Burbank, CA (US)

(72) Inventors: Sen WU, Shenzhen (CN); Weihan SHE, Shenzhen (CN); Wenping ZENG, Shenzhen (CN); Kefeng ZHOU, Shenzhen (CN)

(21) Appl. No.: 19/298,866

(22) Filed: Aug. 13, 2025

(30) Foreign Application Priority Data
Aug. 16, 2024 (CN) 202422007018.6

(51) Int. Cl. B62B 3/04; B62B 3/02

(52) U.S. Cl. CPC B62B 3/04; B62B 3/02; B62B 2203/44

(57) ABSTRACT

The present application introduces a mobile workstation, including: a storage main body, which includes a support section and multiple storage platforms sequentially installed on the support section along its height direction; and an extension table mounted on either the storage platform or the support section. The extension table features a tabletop surface that incorporates a table module, thereby enhancing the storage flexibility of the mobile workstation.

### CROSS-REFERENCE TO RELATED APPLICATIONS

The present application for patent claims priority to and the benefit of pending Chinese Application No. 202422007018.6, filed on Aug. 16, 2024, and hereby expressly incorporated by reference herein as if fully set forth below in its entirety and for all applicable purposes.

### TECHNICAL FIELD

The present disclosure pertains to the technical field of extension accessories, more particularly to a mobile workstation.

### INTRODUCTION

In daily life, a mobile workstation serves as an auxiliary vehicle, typically designed for work or outdoor activities. For instance, users can load photographic accessories onto the mobile workstation in specific scenarios.

Conventional mobile workstations generally include multiple storage platforms connected by support columns, with wheels installed on the bottom storage platform for mobility. Workers typically place photographic accessories on these storage platforms, which serve as the primary storage areas. However, such configurations can oversimplify the storage requirements of mobile workstations, making it challenging to meet users' diverse needs.

### BRIEF SUMMARY

Aspects of the present disclosure provide a mobile workstation that addresses the limitation in prior art where storage requirements are oversimplified, failing to satisfy user demands.

Some aspects of the disclosure provided:

A mobile workstation, including:
a storage main body, including a support section and one or more storage platforms sequentially installed on the support section along its height direction;
an extension table mounted on either the storage platform or the support section, featuring a tabletop surface that incorporates table module.

In one aspect, the table module includes a table module slot designed to accommodate at least one type of table accessory.

The table accessory can include, but is not limited to, a tabletop, a stove, a rack, a gas burner, or a storage basket.

The table module slot includes at least 0.5 unit sizes.

In one aspect, the extension table includes a storage assembly with a tabletop surface, where one side of the storage assembly can abut or be mounted on the storage platform; and

A support assembly including a support member and a first mounting member.

The support member includes a first end and a second end, with the first end featuring a first abutment part and the second end featuring a second abutment part. The first end of the support member is movably connected to the storage assembly, allowing the first abutment part to abut the storage assembly. The first mounting member is movably connected to the second end of the support member, enabling the second abutment part to abut the first mounting member or the support section. The first mounting member can be mounted on the support section.

The disclosure also provides a mobile workstation, including a storage main body and the aforementioned extension table. The storage main body includes multiple storage platforms and multiple support columns, with four support columns installed at the four corners of the bottom storage platform and another portion of the storage platforms sequentially installed on the support columns, enabling the storage platforms to be stacked on the support columns layer by layer.

Herein, the storage assembly abuts or clamps onto one of the storage platforms, and the first mounting member is mounted on the support column.

In this disclosure, the mobile workstation incorporates an extension table with an table module, forming a compatible modular system. This allows for the integration of various table accessories, providing users with enhanced freedom and flexibility in configuration.

### BRIEF DESCRIPTION OF THE DRAWINGS

The following provides a brief description of the accompanying drawings for implementation of exemplary embodiments of the present disclosure. Notably, the drawings represent only exemplary embodiments, and other derived configurations can be obtained by those skilled in the art without creative effort.

FIG. 1 is a schematic drawing of a mobile workstation according to some aspects of the disclosure.

FIG. 2 is a right-side view of an extension table according to some aspects of the disclosure.

FIG. 3 is a schematic drawing of a support member according to some aspects of the disclosure.

FIG. 4 is an exploded view of an extension table according to some aspects of the disclosure.

FIG. 5 is an enlarged view of section A in FIG. 4.

FIG. 6 is a cross-sectional view of an extension table according to some aspects of the disclosure.

FIG. 7 is an enlarged view of section B in FIG. 6.

FIG. 8 is a schematic drawing of a support assembly according to some aspects of the disclosure.

FIG. 9 is a cross-sectional view taken along section line A-A in FIG. 8.

FIG. 10 is an enlarged view of section C in FIG. 9.

FIG. 11 is another cross-sectional view of an extension table according to some aspects of the disclosure.

FIG. 12 is a schematic diagram of a storage assembly according to some aspects of the disclosure.

FIG. 13 is a schematic diagram of a hanging member according to some aspects of the disclosure.

### REFERENCE NUMERALS

100. mobile workstation; 10. extension table; 20. storage main body; 201. support section; 2011. support column; 202. storage platform; 2021. platform edge; 30. wheel;
1. storage assembly; 11. tabletop surface; 12. storage member; 121. peripheral side; 122. first sliding groove; 1221. first inclined surface; 13. second mounting member; 131. clamping member; 132. clamping slot; 133. first spacer; 14. first locking member; 141. first actuating part; 142. first trigger part; 15. connection base; 151. first connection part; 1511. second receiving groove; 1512. first protrusion; 1513. second protrusion; 1514. first pivot shaft; 152. first slider; 1521. second inclined surface; 1522. first receiving groove; 1523. first through hole; 16. second sliding groove; 161. third inclined surface; 162. first groove wall; 163. second groove wall; 164. releasing groove; 17. table module; 18. table module slot; 181. table accessory; 19. notch;
2. support assembly; 21. support member; 211. first end; 212. first abutment part; 2121. first abutment plane; 213. second end; 214. second abutment part; 2141. second abutment plane; 22. first mounting member; 221. first clamping block; 222. third protrusion; 223. fourth protrusion; 224. second pivot shaft; 225. first clamping part; 2251. mounting space; 2252. fixed shaft; 226. second clamping part; 2261. opening; 227. third locking part; 2271. first locking shaft; 2272. locking handle; 22721. handle; 22722. locking post; 22723. spring; 22724. screw;
3. hanging member; 31. second connection part; 32. second slider; 312. fourth inclined surface;
4. second locking member;
5. second spacer.

The objectives, functional features, and aspects of this application will be further explained with reference to the embodiments and accompanying drawings.

### DETAILED DESCRIPTION

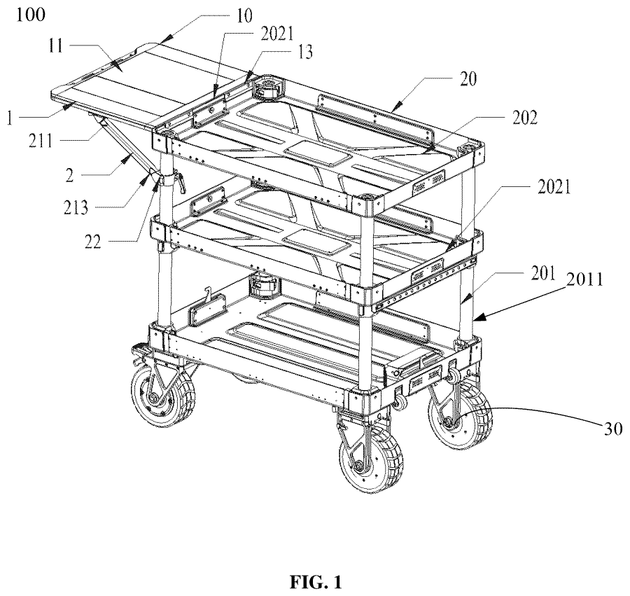

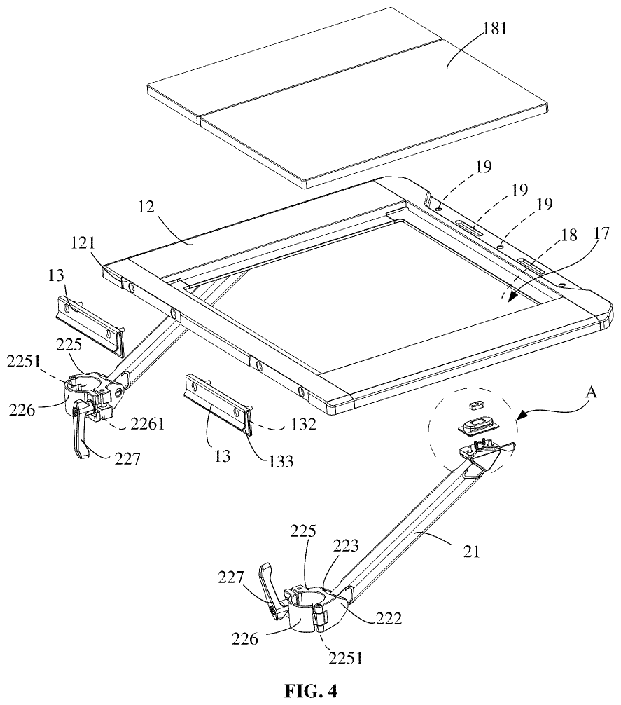

Referring to FIGS. 1 and 4, the mobile workstation 100 of the present application includes a storage main body 20 and an extension table 10. The storage main body 20 includes a support section 201 and multiple storage platforms 202, with the multiple storage platforms 202 being sequentially installed on the support section 201 along its height direction. The extension table 10 is mounted either on the storage platform 202 or the support section 201, and it includes a tabletop surface 11 that incorporates an table module 17.

In this disclosure, the mobile workstation 100 incorporates the extension table 10, which features the table module 17 (e.g., Iron Grill Table). The table module 17 is a modular system capable of accommodating various table accessories 181, providing users with greater freedom and flexibility in configuration.

The support section 201 includes four support columns 2011, and the height direction of the support section 201 corresponds to the height direction of the four support columns 2011, that is, the height direction of the mobile workstation 100.

The present disclosure provides a mobile workstation 100, including the storage main body 20 and the extension table 10. The mounting object here can include, but is not limited to, the storage main body 20. Any object capable of mounting the extension table 10 can be considered as the mounting object. The extension table 10 can be installed on the storage main body 20, thereby enhancing the storage space and flexibility of the storage main body 20 to effectively meet users' storage needs. The mounting object here can include multiple storage platforms 202 and multiple support columns 2011. Referring to FIG. 1, this example demonstrates four support columns 2011 and three storage platforms 202. The four support columns 2011 are connected to the four corners of one storage platform 202 (e.g., the bottom storage platform 202), while the other two storage platforms 202 are also connected to the four support columns 2011, enabling the storage platforms 202 to be stacked layer by layer on the support columns 2011. Each layer of the storage platforms 202 can be used to place items as desired by the user. The bottom storage platform 202 can also be equipped with wheels 30 to facilitate the mobility of the mobile workstation 100.

The table module 17 is positioned on the tabletop surface 11. In some aspects, the tabletop surface 11 is provided with an table module slot 18, which is designed to mount at least one type of table accessory 181. This arrangement enables the table module slot 18 to universally accommodate various commercially available table accessories 181, such as tabletops, stoves, racks, storage baskets, gas burners, etc., facilitating users' work and outdoor activities. For instance, in a photography setting, users can utilize aa tabletop as a work surface or employ a storage basket to hold additional items. Alternatively, during outdoor work or activities, users can use the table module slot 18 to install a stove for cooking, boiling water, or grilling during leisure time. Referring to FIG. 4, the tabletop surface 11 further includes at least one notch 19, designed to engage with the clamping member 131. The notch 19 can vary in size to accommodate universal table accessory 181 products such as hooks, hanging rods, or clasps. In some aspects, the table module slot 18 here can be configured in different unit sizes, with one standard unit size typically measuring 25× 36 cm.

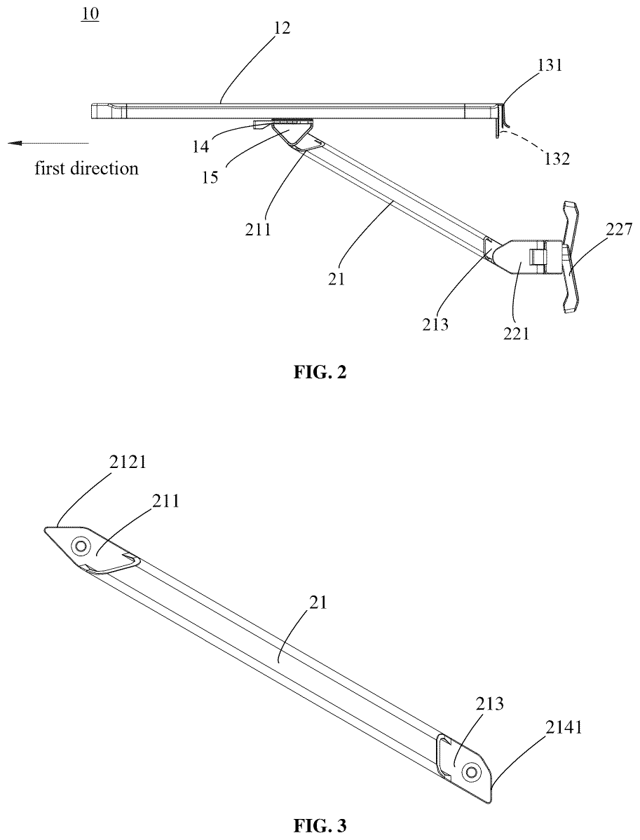

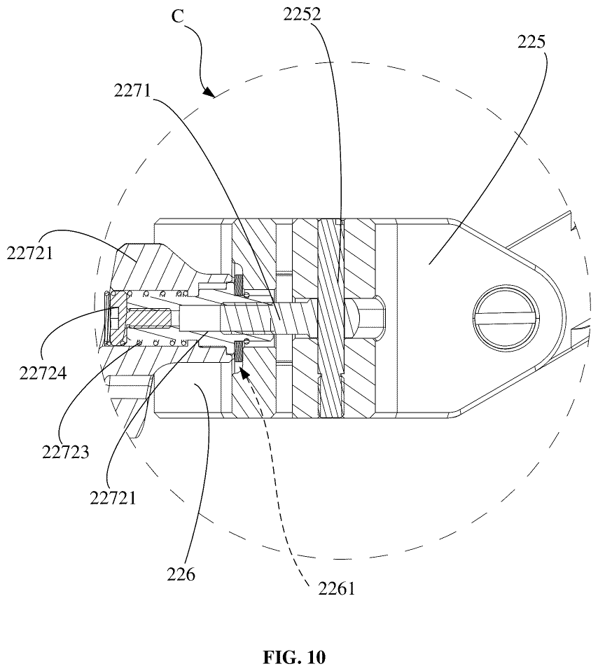

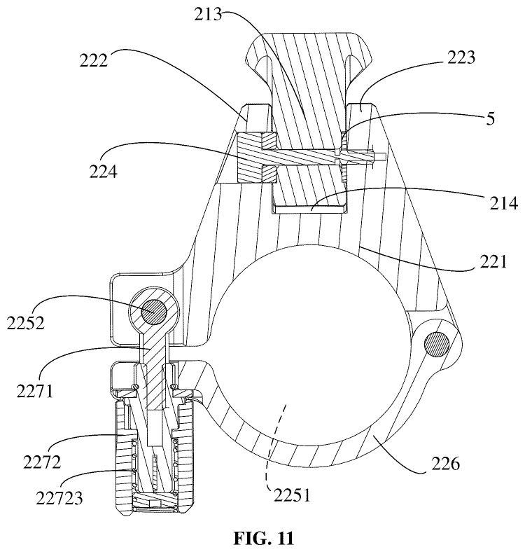

Referring to FIGS. 2-11, an extension table 10 can include a storage assembly 1 and a support assembly 2. The storage assembly 1 includes the tabletop surface 11, and one side of the storage assembly 1 can abut or be mounted on the mounting object. The support assembly 2 includes at least one support member 21 and at least one first mounting member 22. A first end 211 of the support member 21 is movably connected to the storage assembly 1, and the first end 211 is provided with a first abutment part 212, which can abut the storage assembly 1. The first mounting member 22 is movably connected to a second end 213 of the support member 21, and the second end 213 is provided with a second abutment part 214, which can abut the first mounting member 22 or the mounting object. The first mounting member 22 can be mounted on the mounting object.

From the perspective of FIG. 2, the support member 21 is movably connected to both the storage assembly 1 and the first mounting member 22. The first mounting member 22 can be mounted on the support column 2011 of the storage main body 20. Additionally, the second end 213 of the support member 21 abuts the first mounting member 22 via the second abutment part 214, enabling the support member 21 to indirectly abut the support column 2011. In this configuration, the support column 2011 provides a supporting force to the support member 21, ensuring that the second end 213 of the support member 21 remains stably supported on the first mounting member 22. Furthermore, the first end 211 of the support member 21 is connected to the storage assembly 1, and the first abutment part 212 abuts the storage assembly 1 to prevent it from flipping. One side of the storage assembly 1 can abut or be mounted on the storage platform 202 of the storage main body 20, allowing the storage platform 202 and the support member 21 to jointly provide supporting forces to the storage assembly 1. This ensures stable installation of the storage assembly 1 on the storage main body 20 and enables the storage assembly 1 to bear items. Users can place desired items on the tabletop surface 11 of the storage assembly 1, thereby expanding the storage space of the storage main body 20. When the storage assembly 1 is not in use, the first mounting member 22 can be disassembled, and the support member 21 can be rotated relative to the storage assembly 1 for storage, such as placement inside the storage platform 202. In some aspects, the second abutment part 214 of the support member 21 can also directly abut the mounting object, for example, the support column 2011 of the storage main body 20. The storage assembly 1 and the first mounting member 22 here can be mounted at two different locations on the storage main body 20. For example, one side of the storage assembly 1 can abut or be mounted on the storage platform 202, while the first mounting member 22 can be mounted on the support column 2011.

Referring to FIG. 1, one end of the storage assembly 1 can also rest on or clamp onto the platform edge 2021 of the storage platform 202, thereby allowing the storage platform 202 to support the storage assembly 1 and ensuring load-bearing stability. This embodiment will use clamping as an example. The storage assembly 1 can include a storage member 12 and a second mounting member 13, wherein the second mounting member 13 is connected to the storage member 12 and designed to mount the storage member 12 onto the mounting object. This arrangement enables the second mounting member 13 to be mounted on the platform edge 2021 of the storage platform 202, enhancing the installation stability of the storage assembly 1. In some aspects, the second mounting member 13 includes a clamping member 131, which is fixed to the peripheral side 121 of the storage member 12. The clamping member 131 has a clamping slot 132, with its opening facing away from the tabletop surface 11, and the clamping slot 132 is designed to clamp onto the mounting object. During use, the clamping slot 132 can be clamped onto the platform edge 2021 of the storage platform 202, while the first mounting member 22 can be mounted on the support column 2011 of the storage main body 20, forming a stable triangular support structure.

In some aspects, referring to FIG. 4, a first spacer 133 can be provided on the inner wall of the clamping slot 132 to reduce wear between the slot wall and the platform edge 2021 of the storage platform 202.

Referring to FIGS. 3, 7, and 11, and also from the perspective of FIG. 2, in some embodiments, the first abutment part 212 and the second abutment part 214 can be snap-fit structures or flat surfaces such as a first abutment plane 2121. This embodiment will use the first abutment plane 2121 as an example. Taking the first abutment part 212 as an example, the first end 211 of the support member 21 includes a first abutment plane 2121. The storage assembly 1 further includes the storage member 12, a first protrusion 1512, and a second protrusion 1513, wherein the first protrusion 1512 and the second protrusion 1513 are connected to the side of the storage member 12 opposite the tabletop surface 11. The first end 211 of the support member 21 is accommodated between the first protrusion 1512 and the second protrusion 1513, and the first protrusion 1512 and the second protrusion 1513 are rotatably connected to the first end 211 of the support member 21 via a first pivot shaft 1514. The first abutment part 212 includes the first abutment plane 2121, which can abut and be limited to the side of the storage member 12 opposite the tabletop surface 11, thereby preventing the storage member 12 from flipping and providing stable support for the storage member 12.

In some aspects, the storage member 12 rests on the platform edge 2021 of the storage platform 202 or is connected to the aforementioned clamping member 131 of the second mounting member 13, enabling it to clamp onto the platform edge 2021. The opening of the clamping slot 132 in the clamping member 131 faces downward, allowing the platform edge 2021 to provide supporting force to the storage member 12. This makes the installation position of the support member 21 on the storage member 12 more flexible. For example, the first end 211 of the support member 21 can include a first abutment plane 2121, which is generally a horizontally arranged plane extending away from the clamping member 131, for example, the first abutment plane 2121 extends from first pivot shaft 1514 in a first direction. From the perspective of FIG. 2, the first direction is to the left of the first pivot shaft 1514 and generally parallel to the tabletop surface 11. With this configuration, when a user places an item on the end of the tabletop surface 11 that is slightly farther from the storage main body 20, the first abutment plane 2121 can prevent the storage member 12 from flipping, thereby providing support. Conversely, when an item is placed on the end of the tabletop surface 11 closer to the storage main body 20, the platform edge 2021 can support the tabletop surface 11, ensuring more stable load-bearing.

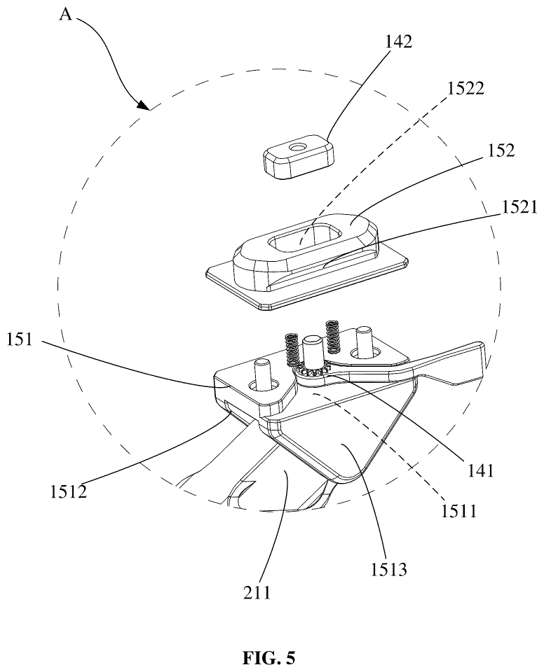

Referring to FIG. 5, if the installation position of the support member 21 on the storage member 12 is flexible, in one embodiment, the extension table 10 can be adapted to storage main bodies 20 of various specifications. For example, different storage main bodies 20 can have varying distances between the platform edge 2021 of the storage platform 202 and the support column 2011. This application provides a solution wherein the storage assembly 1 includes the storage member 12, a first locking member 14, and a connection base 15. The storage member 12 features the tabletop surface 11, and the connection base 15 is slidably connected to the side of the storage member 12 opposite the tabletop surface 11. The first locking member 14 is movably connected to the connection base 15 and is configured to lock or unlock the connection base 15 and the storage member 12. The first end 211 of the support member 21 is movably connected to the connection base 15, and the first abutment part 212 can abut the side of the connection base 15 opposite the tabletop surface 11. For example, from the perspective of FIG. 2, if the distance between the support column 2011 and the platform edge 2021 of the storage platform 202 is large, the first locking member 14 can be unlocked, and the connection base 15 can be slid to the right relative to the storage member 12 to an appropriate distance before being locked again with the first locking member 14, thereby adapting to this specification of the storage main body 20. Conversely, if the support column 2011 is closer to the storage platform 202, the first locking member 14 can be unlocked, and the connection base 15 can be slid to the left relative to the storage member 12 to an appropriate distance before being locked again with the first locking member 14, thereby adapting to this specification of the storage main body 20. Notably, in some aspects, the first protrusion 1512 and the second protrusion 1513 can be provided on the side of the connection base 15 opposite the tabletop surface 11, and the first end 211 of the support member 21 is movably connected to the first protrusion 1512 and the second protrusion 1513 via the first pivot shaft 1514, with the first abutment part 212 abutting the side of the connection base 15 opposite the tabletop surface 11.

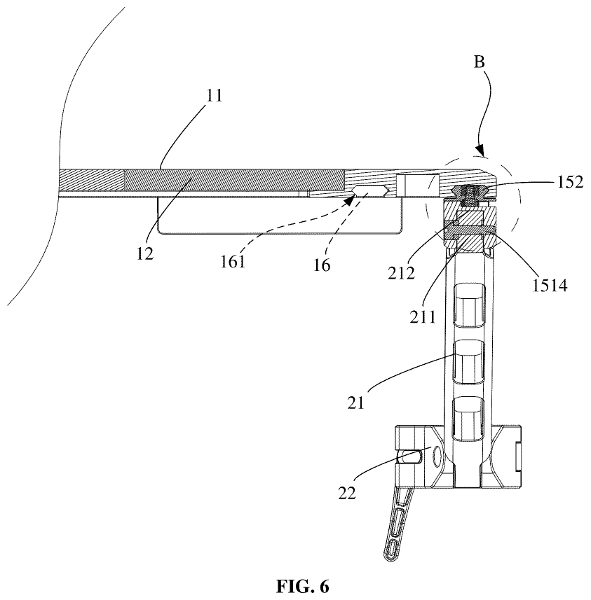

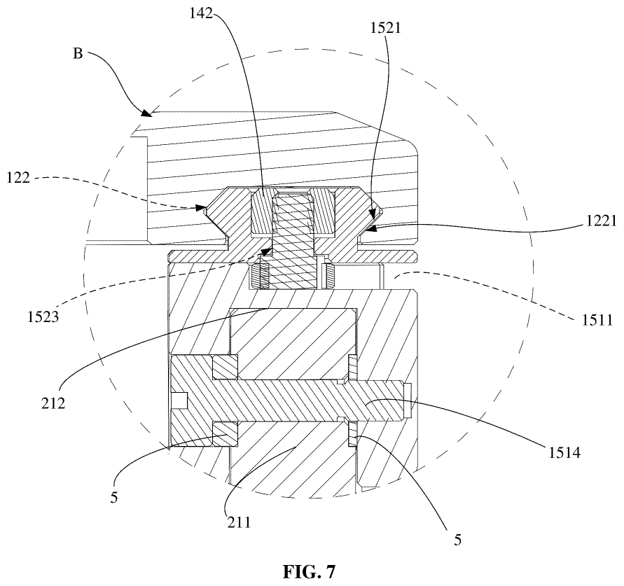

Referring to FIGS. 6-7, in some aspects, the side of the storage member 12 opposite the tabletop surface 11 is equipped with a first sliding groove 122, which has a first inclined surface 1221. The connection base 15 includes a first connection part 151 and a first slider 152 slidably disposed in the first sliding groove 122. The first connection part 151 is connected to the first slider 152, and the first slider 152 has a second inclined surface 1521. The first locking member 14 can press or release the first inclined surface 1221 and the second inclined surface 1521 to lock or unlock the connection base 15 and the storage member 12. Alternatively, the side of the storage member 12 opposite the tabletop surface 11 is equipped with the first slider 152 with the first inclined surface 1221, while the connection base 15 includes the first connection part and the first sliding groove 122, which is slidably placed with the first slider 152 with the second inclined surface 1521. The first locking member 14 can press or release the first inclined surface 1221 and the second inclined surface 1521 to lock or unlock the connection base 15 and the storage member 12. On the one hand, the first locking member 14 can be a bidirectional screw passing through the groove wall of the first sliding groove 122 and the first slider 152. When the screw is rotated, the first inclined surface 1221 and the second inclined surface 1521 are pressed together. Notably, in some aspects, the first protrusion 1512 and the second protrusion 1513 can be provided on the side of the first connection part 151 opposite the tabletop surface 11.

Referring to FIG. 7, another implementation of the first locking member 14 is described here, where the storage member 12 has the first sliding groove 122, and the connection base 15 includes the first slider 152. The first locking member 14 includes a first actuating part 141 and a first trigger part 142. The first slider 152 has a first receiving groove 1522, with a first through hole 1523 at its bottom. The first connection part 151 has a second receiving groove 1511. The first trigger part 142 is accommodated in the first receiving groove 1522, and the first actuating part 141 is accommodated in the second receiving groove 1511, with one end passing through the first through hole 1523 and extending into the first receiving groove 1522 to threadedly connect with the first trigger part 142. The first actuating part 141 can rotate relative to the first connection part 151, causing the first actuating part 141 and the first trigger part 142 to move closer or farther apart, thereby pressing or releasing the first inclined surface 1221 and the second inclined surface 1521. In some embodiments, from the perspective of FIGS. 2 and 7, when the first actuating part 141 is rotated in the locking direction, the threaded connection between the first actuating part 141 and the first trigger part 142 causes the first trigger part 142 to move upward relative to the first actuating part 141, while the first actuating part 141 moves downward relative to the first trigger part 142, driving the first slider 152 and the first connection part 151 downward. This presses the second inclined surface 1521 against the first inclined surface 1221, locking the storage member 12 and the connection base 15. Conversely, rotating the first actuating part 141 in the unlocking direction causes the first trigger part 142 to move downward relative to the first actuating part 141 and the first actuating part 141 to move upward relative to the first actuating part 141, driving the first slider 152 and the first connection part 151 upward, releasing the pressure between the first and the second inclined surfaces 1221 and 1521, and unlocking the storage member 12 and the connection base 15.

Referring to FIGS. 3 and 11, regarding the second abutment part 214, it can also include a second abutment plane 2141. In the installed state, this second abutment plane 2141 is generally parallel to the axial direction of the support column 2011. In some embodiments, the first mounting member 22 has a mounting space 2251 for inserting the support column 2011. The first mounting member 22 includes a first clamping block 221, a third protrusion 222, and a fourth protrusion 223. The third protrusion 222 and the fourth protrusion 223 are connected to the side of the first clamping block 221 opposite the mounting space 2251. The second end 213 of the support member 21 is accommodated between the third protrusion 222 and the fourth protrusion 223, and the third protrusion 222 and the fourth protrusion 223 are rotatably connected to the second end 213 of the support member 21 via a second pivot shaft 224. The second abutment part 214 has the second abutment plane 2141, which can abut the side of the first clamping block 221 opposite the mounting space 2251. This ensures that, in the installed state, the first mounting member 22 is securely locked onto the support column 2011, and the support member 21 can indirectly abut the support column 2011 by abutting the first mounting member 22. In other words, the support column 2011 provides a supporting force to the support member 21 in this example.

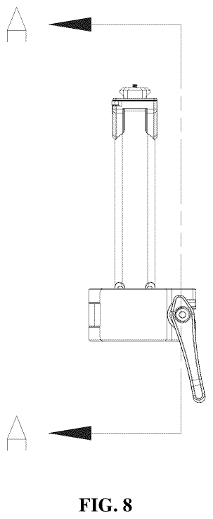

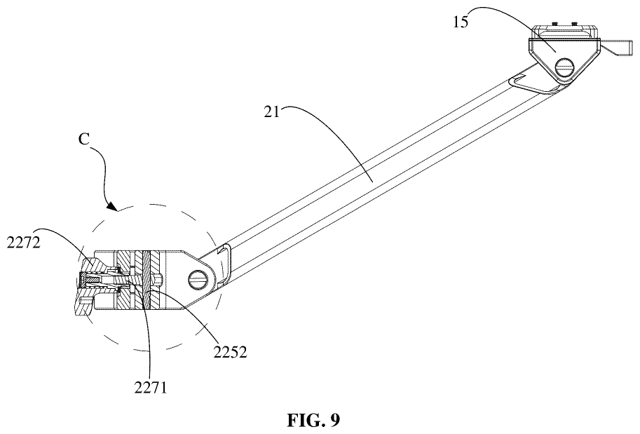

Referring to FIGS. 8-10, in one aspect, the manner in which the first end 211 of the support member 21 is movably connected between the first protrusion 1512 and the second protrusion 1513, and the manner in which the second end 213 of the support member 21 is movably connected between the third protrusion 222 and the fourth protrusion 223, can be consistent. This embodiment will use the movable connection of the second end 213 of the support member 21 as an example. The second pivot shaft 224 passes through the third protrusion 222 and the fourth protrusion 223 and is threadedly connected to the fourth protrusion 223. The second end 213 of the support member 21 is rotatably sleeved on the second pivot shaft 224 and can rotate relative to it. In some aspects, multiple second spacers 5 can be sleeved on the second pivot shaft 224, with one spacer placed between the second end 213 of the support member 21 and the third protrusion 222, and another spacer placed between the second end 213 and the fourth protrusion 223. The positioning of the second spacers 5 on the first pivot shaft 1514 follows the same method as on the second pivot shaft 224, which will not be elaborated here.

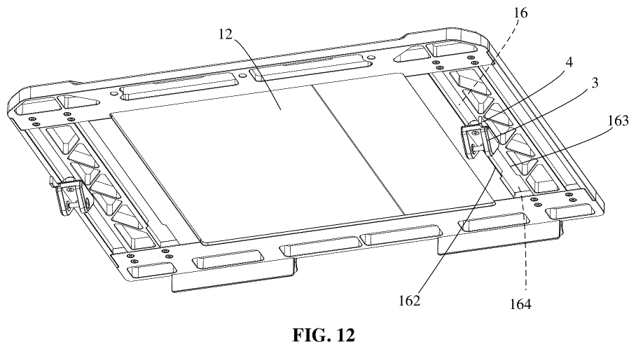

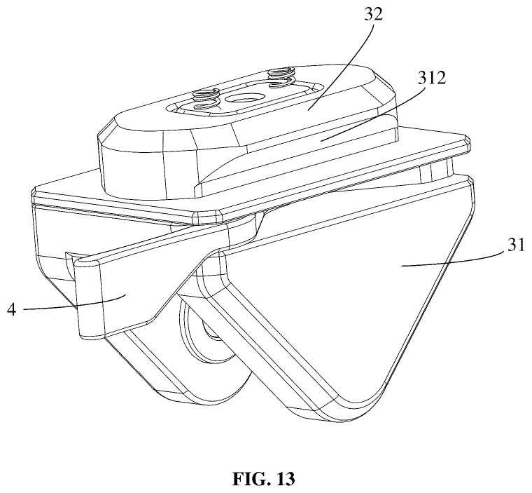

In some aspects, referring to FIGS. 12-13. The extension table 10 further includes a hanging member 3 (which can share the same structure as the connection base 15) and a second locking member 4. The hanging member 3 is slidably positioned on the side of the storage assembly 1 opposite the tabletop surface 11, and the second locking member 4 is capable of locking or unlocking the hanging member 3 and the storage assembly 1. This setup enables users to hang various accessories at multiple locations on the side of the storage assembly 1 opposite the tabletop surface 11. For instance, if a user desires to change the hanging position, they can unlock the second locking member 4 to release and move the hanging member 3 to the desired location, and then secure it on the side of the storage assembly 1 opposite the tabletop surface 11 by tightening the second locking member 4. Consequently, this further expands the storage space of the tabletop surface 11. In some aspects, the side of the storage assembly 1 opposite the tabletop surface 11 can also be equipped with a second sliding groove 16, which features a third inclined surface 161. The hanging member 3 includes a second connection part 31 and a second slider 32 that is slidably positioned within the second sliding groove 16. The second slider 32 has a fourth inclined surface 312, and the first locking member 14 can press or release the third inclined surface 161 and the fourth inclined surface 312 to lock or unlock the hanging member 3 and the storage assembly 1. The locking and unlocking manners of the second locking member 4 align with the two embodiments of the first locking member 14 described previously. Therefore, this will not be further elaborated on here, and the operation of the second locking member 4 can be referenced to that of the first locking member 14. In another aspect, the second sliding groove 16 includes a first groove wall 162 and a second groove wall 163. At least one end of the first groove wall 162 and the second groove wall 163 of the second sliding groove 16 extends in diverging directions to form a releasing groove 164, allowing the hanging member 3 to detach from the storage assembly 1. It should be clarified that the diverging inclination of the first groove wall 162 and the second groove wall 163 creates a larger releasing groove 164, facilitating easier removal of the hanging member 3 by users when it is not required.

Further, this disclosure explains the installation process of the first mounting member 22 on the support column 2011. Referring to FIGS. 8-10, the first mounting member 22 includes a first clamping block 221 and a third locking part 227. The first clamping block 221 includes a first clamping part 225 and a second clamping part 226, with a mounting space 2251 formed between them for installing the support column 2011 of the storage main body 20. The side of the first clamping part 225 opposite the mounting space 2251 is movably connected to the second end 213 of the support member 21, and this side can also abut the second abutment part 214 to support the support member 21. The aforementioned third protrusion 222 and fourth protrusion 223 can be provided on the side of the first clamping part 225 opposite the mounting space 2251.

In some aspects, one end of the first clamping part 225 is movably connected to one end of the second clamping part 226, while the second end 213 of the first clamping part 225 is movably connected to the third locking part 227. The second end 213 of the second clamping part 226 features an opening 2261, and the third locking part 227 can rotate relative to the first clamping part 225 to be accommodated in the opening 2261 and press firmly against the second clamping part 226, thereby locking the mounting object in the mounting space 2251. In some aspects, users can install the first clamping part 225 and the second clamping part 226 around the support column 2011, place the support column 2011 in the mounting space 2251, and then rotate the third locking part 227 to press firmly against the second clamping part 226, completing the installation of the first mounting member 22. To disassemble, the third locking part 227 is rotated to release pressure on the second clamping part 226 and exit the opening 2261, allowing the first clamping part 225 and the second clamping part 226 to open and the first mounting member 22 to be removed.

In some aspects, concerning the locking process of the third locking part 227, the third locking part 227 includes a first locking shaft 2271 and a locking handle 2272. One end of the first locking shaft 2271 is rotatably sleeved on a fixed shaft 2252 provided at one end of the first clamping part 225, while the other end is threadedly connected to the locking handle 2272. The locking handle 2272 can drive the first locking shaft 2271 to rotate around the axial direction of the fixed shaft 2252 until it is accommodated in the opening 2261. Additionally, the locking handle 2272 can rotate around the axial direction of the first locking shaft 2271 to press firmly against the second clamping part 226. In some aspects, when locking is required, the user can grip the locking handle 2272 to rotate the first locking shaft 2271 around the fixed shaft 2252 until it enters the opening 2261. Then, rotating the locking handle 2272 around the axial direction of the first locking shaft 2271 causes the locking handle 2272 and the first locking shaft 2271 to move closer, pressing the locking handle 2272 firmly against the second clamping part 226, thereby tightly clamping the first clamping part 225 and the second clamping part 226 around the support column 2011. To unlock, the locking handle 2272 is first rotated around the axial direction of the first locking shaft 2271 to move the locking handle away from the first locking shaft 2271, so as to release pressure from the locking handle 2272 on the second clamping part 226, after which the first locking shaft 2271 can be rotated around the fixed shaft 2252 out of the opening 2261 by gripping the locking handle 2272 to complete unlocking, allowing the first clamping part 225 and the second clamping part 226 to be removed from the support column 2011.

In some aspects, the locking handle 2272 can include a handle 22721 and a locking post 22722. One end of the locking post 22722 is threadedly connected to the first locking shaft 2271, while the other end is threadedly connected to a screw 22724. The handle 22721 is sleeved on the locking post 22722, and a spring 22723 is also sleeved on the locking post 22722, with its ends abutting between the handle 22721 and the screw 22724, ensuring stable positioning of the handle 22721 on the locking post 22722. Additionally, the handle 22721 and the locking post 22722 are hexagonally engaged, so rotating the handle 22721 drives the locking post 22722 to rotate.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

As used herein, the term “part” (or “parts”) refers to a component, element, member, or portion of a system or device and is intended to be understood in a general structural sense. Unless expressly stated otherwise, the use of the term “part” is not intended to invoke 35 U.S.C. § 112 (f) (or pre-AIA § 112, sixth paragraph), and should not be construed as a means-plus-function limitation. Instead, “part” refers to a tangible element that may perform one or more functions described herein, either alone or in combination with other elements.

What is claimed is:

1. A mobile workstation, comprising:
a storage main body comprising a support section and a plurality of storage platforms, wherein the plurality of storage platforms are sequentially provided along a height direction of the support section; and
an extension table provided on at least one of the plurality of storage platforms or the support section, wherein the extension table comprises a tabletop surface, and the tabletop surface comprises an table module.

2. The mobile workstation according to claim 1, wherein the table module comprises an table module slot, and the table module slot is configured for mounting at least one table accessory.

3. The mobile workstation according to claim 2, wherein the table accessory can comprise at least one of a tabletop, a stove, a rack, a gas burner, or a storage basket.

4. The mobile workstation according to claim 2, wherein the table module slot has a size of at least 0.5 unit size.

5. The mobile workstation according to claim 1, wherein the table module comprises a notch formed on the tabletop surface, and the notch is configured to engage a hook, a hanging rod, or a latch.

6. The mobile workstation according to claim 1, wherein the extension table comprises:
a storage assembly comprising the tabletop surface, wherein one side of the storage assembly is configured to abut or mount onto the at least one of the storage platforms; and
a support assembly comprising a support member and a first mounting member, wherein the support member comprises a first end and a second end;
wherein the first end is provided with a first abutment part;
wherein the second end is provided with a second abutment part;
wherein the first end of the support member is movably connected to the storage assembly, and the first abutment part is configured to abut the storage assembly;
wherein the first mounting member is movably connected to the second end of the support member, and the second abutment part is configured to abut the first mounting member or the support section; and
wherein the first mounting member is configured to mount onto the support section.

7. The mobile workstation according to claim 6, wherein the storage assembly comprises a storage member and a second mounting member;
wherein the storage member comprises the tabletop surface;
wherein the first end of the support member is movably connected to the storage member, and the first abutment part is configured to abut the storage member; and
wherein the second mounting member is connected to the storage member, and the second mounting member is configured to mount onto the at least one of the storage platforms.

8. The mobile workstation according to claim 7, wherein the second mounting member comprises a clamping member;
wherein the clamping member is fixedly connected to a peripheral side of the storage member;
wherein the clamping member is configured with a clamping slot;
wherein an opening of the clamping slot faces away from the tabletop surface; and
wherein the clamping slot is configured to clamp onto the at least one of the storage platforms.

9. The mobile workstation according to claim 6, wherein the storage assembly comprises a storage member, and the storage member further comprises a first locking member and a connection base;
wherein the storage member comprises the tabletop surface;
wherein the connection base is slidably connected to a side of the storage member opposite to the tabletop surface;
wherein the first locking member is movably connected to the connection base and is configured to lock or unlock the connection base and the storage member;
wherein the first end of the support member is movably connected to the connection base; and
wherein the first abutment part is configured to abut a side of the connection base opposite to the tabletop surface.

10. The mobile workstation according to claim 9, wherein the storage member is provided with a first sliding groove on a side opposite to the tabletop surface, and the first sliding groove has a first inclined surface;
wherein the connection base comprises a first connection part and a first slider, the first slider is slidably disposed in the first sliding groove, the first connection part is connected to the first slider, and the first slider has a second inclined surface; and
wherein the first locking member is configured to press the first inclined surface and the second inclined surface to lock the connection base and the storage member, or release the first inclined surface and the second inclined surface to unlock the connection base and the storage member.

11. The mobile workstation according to claim 10, wherein the first locking member comprises a first actuating part and a first trigger part;
wherein the first slider is provided with a first receiving groove, and a bottom of the first receiving groove is provided with a first through hole;
wherein the first connection part is provided with a second receiving groove;
wherein the first trigger part is received in the first receiving groove;
wherein the first actuating part is received in the second receiving groove, with one end extending through the first through hole into the first receiving groove and threadedly engaged with the first trigger part; and
wherein the first actuating part is rotatable relative to the first connection part to move the first actuating part and the first trigger part closer or farther apart, thereby pressing or releasing the first inclined surface and the second inclined surface.

12. The mobile workstation according to claim 10, wherein the connection base comprises a first protrusion and a second protrusion, the first protrusion and the second protrusion are connected to a side of the first connection part opposite to the tabletop surface;
wherein the first end of the support member is received between the first protrusion and the second protrusion, and the first protrusion and the second protrusion are rotatably connected to the first end via a first pivot shaft; and
wherein the first abutment part comprises a first abutment plane, and the first abutment plane is configured to abut and limit movement of the first connection part on the side opposite to the tabletop surface.

13. The mobile workstation according to claim 12, wherein the first abutment plane extends away from the clamping member.

14. The mobile workstation according to claim 6, wherein the extension table further comprises a hanging member and a second locking member; wherein the hanging member is slidably provided on a side of the storage assembly opposite to the tabletop surface; and
wherein the second locking member is configured to lock or unlock the hanging member and the storage assembly.

15. The mobile workstation according to claim 6, wherein the first mounting member comprises a first clamping part, a second clamping part, and a third locking part;
wherein a mounting space is formed between the first clamping part and the second clamping part for mounting an object;
wherein a side of the first clamping part opposite to the mounting space is movably connected to the second end of the support member, and the side of the first clamping part opposite to the mounting space is configured to abut the second abutment part;
wherein one end of the first clamping part is movably connected to one end of the second clamping part, and another end of the first clamping part is movably connected to the third locking part; and
wherein another end of the second clamping part is provided with an opening, and the third locking part is rotatable relative to the first clamping part to be received in the opening and press against the second clamping part to lock the object in the mounting space.

16. The mobile workstation according to claim 15, wherein the first clamping part comprises a first clamping block, a third protrusion, and a fourth protrusion;
wherein the third protrusion and the fourth protrusion are connected to a side of the first clamping block opposite to the mounting space;
wherein the second end of the support member is received between the third protrusion and the fourth protrusion, and the third protrusion and the fourth protrusion are rotatably connected to the second end via a second pivot shaft; and
wherein the second abutment part comprises a second abutment plane, and the second abutment plane is configured to abut the side of the first clamping block opposite to the mounting space.

17. The mobile workstation according to claim 1, wherein the storage main body further comprises wheels;
wherein the support section comprises one or more support columns;
wherein four of the support columns are mounted at four corners of a bottom storage platform, and remaining storage platforms are sequentially mounted along a height direction of the four support columns, stacking the storage platforms on the support columns sequentially; and
wherein the wheels are mounted at a bottom of the bottom storage platform.
